(19) United States
(12) Patent Application Publication
(10) Pub. No.: US 2015/0345446 A1
(43) Pub. Date: Dec. 3, 2015

(54) METHOD OF MITIGATING AXIAL LOADS ON PLUNGER OF FUEL PUMPS

(71) Applicant: Caterpillar Inc., Peoria, IL (US)

(72) Inventors: Cuong C. Ly, PEORIA, IL (US); JAY L. RICHERSON, ELMWOOD, IL (US); VICKI S. WELKER, MIDDLEGROVE, IL (US); JOHN A. WHITE, WEST PEORIA, IL (US)

(73) Assignee: Caterpillar Inc., Peoria, IL (US)

(21) Appl. No.: 14/822,904

(22) Filed: Aug. 11, 2015

(51) Int. Cl. F02M 59/20; F02D 41/38; F02M 59/02

(52) U.S. Cl. CPC F02M 59/205; F02M 59/025; F02D 41/38

(57) ABSTRACT

A method of mitigating axial loads on a plunger of a fuel pump is disclosed. The fuel pump includes a compression chamber. The compression chamber receives a supply of fuel while the fuel pump is in an operational state and correspondingly facilitates exertion of an axial load on the plunger. The method initiates with receiving a change in voltage of the strain gauge circuit while the fuel pump is in operation. The change in voltage corresponds to the axial load exerted by the compression chamber on the plunger. Thereafter, the axial load on the plunger is determined by use of the change in the voltage of the strain gauge circuit. The axial load on the plunger is compared with a threshold value. If the axial load breaches the threshold value, the supply of fuel to the compression chamber is altered.

### TECHNICAL FIELD

The present disclosure relates generally to a method of mitigating an axial load on a plunger of a fuel pump. More specifically, the present disclosure relates to the method of mitigating the axial load on the plunger by alteration of a supply of fuel to a compression chamber of the fuel pump.

### BACKGROUND

Fuel pumps are commonly known in the heavy-duty vehicle industry to facilitate a supply of compressed fuel to an engine of a machine. Such a supply is performed at a desired rate and pressure. A fuel pump typically includes a plunger that reciprocates within a compression chamber of the fuel pump, to perform the function of fuel intake and delivery. In application, as the fuel pump receives a supply of fuel in the compression chamber, the plunger reciprocates to compress the fuel, and deliver the compressed fuel to the associated components. Fuel received in the compression chamber exerts an axial load on the plunger. In certain situations, the axial load on the plunger surpasses an average load-bearing capacity of the plunger, inducing undue strain in the plunger. This may occur during high-pressure requirement of the fuel pump, such as when the machine is traversing uphill. Such inducement of strain may shorten the work life of the fuel pump.

Conventionally, the axial load on the plunger is monitored and mitigated by use of a load monitoring system. Generally, the load monitoring system includes a pressure sensor and a control system. The pressure sensor monitors the pressure imparted by the fuel in the compression chamber, to indirectly measure the axial load on the plunger. The control system is set to adjust the supply of fuel as the axial load on the plunger breaches a threshold value for the plunger. Such conventional methods of monitoring of the axial load on the plunger may provide inaccurate results, as the pressure sensor remains vulnerable to the inaccuracies caused by change in temperature and other characteristics of the fuel. This generally leads to inaccurate comprehension of the axial load on the plunger, and, therefore, measures to counter such a condition, as signaled by the pressure sensor, is bound to be an inappropriate response for the mitigation of axial load.

U.S. Pat. No. 7,393,185 discloses a system to control the application of electrical power to a fuel pump. The system includes a pressure sensor subsystem to monitor the pressure in a compression chamber of the fuel pump and to subsequently connect or disconnect the fuel pump to the power supply. Although, this reference describes the pressure sensor subsystem to monitor the pressure in the compression chamber of the fuel pump, pressure sensors remain vulnerable to the characteristic and condition of the fuel, as has been noted above.

### SUMMARY OF THE INVENTION

Various aspects of the present disclosure are directed towards a method of mitigating axial load on a plunger of a fuel pump. The fuel pump includes a compression chamber that receives a supply of fuel in an operational state of the fuel pump. The compression chamber facilitates exertion of the axial load on the plunger corresponding to the supply of fuel in the operational state of the fuel pump. The plunger includes a strain gauge circuit that determines the axial load on the plunger. The method initiates with receiving a change in voltage of the strain gauge circuit. The method then uses the change in voltage of the strain gauge circuit to inversely determine the axial load on the plunger. The determination is based on a comparison of the change in voltage of the strain gauge circuit with a predetermined baseline data. Thereafter, the axial load on the plunger is compared with a threshold value. If the axial load breaches the threshold value, the supply of fuel to the compression chamber of the fuel pump is altered.

### BRIEF DESCRIPTION OF THE DRAWINGS

FIG. 1 is a diagrammatic view of a cross-section of a fuel pump, shown in conjunction with a controller, in accordance with the concepts of the present disclosure;

FIG. 2 is a schematic of a load-monitoring system of the fuel pump of FIG. 1, in accordance with the concepts of the present disclosure;

FIG. 3 is a graphical representation of an axial load sustained by a plunger of the fuel pump of FIG. 1, relative to a cam angle of a cam lobe of the fuel pump of FIG. 1; and

FIG. 4 is a flow chart of a method to mitigate an axial load on the plunger of the fuel pump.

### DETAILED DESCRIPTION

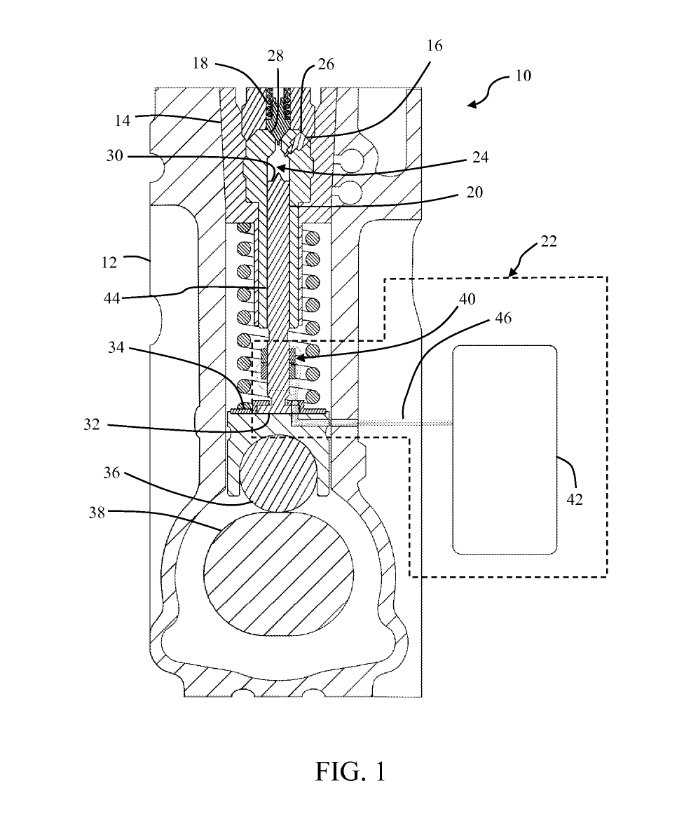

Referring to FIG. 1, there is shown a fuel pump 10. The fuel pump 10 is a high-pressure pump that pumps fuel from a fuel storage tank (not shown) and supplies fuel to a fuel injection system (not shown) of a compression ignition engine (not shown). Although, concepts of the present disclosure are described with reference to the fuel pump 10 used in the compression ignition engine (not shown), applicability to the fuel pumps used in spark ignition engines, may also be contemplated. The fuel pump 10 includes a pump housing 12, a compression cylinder 14, an intake valve 16, an exhaust valve 18, a plunger 20, and a load monitoring system 22.

The pump housing 12 is a hollow structure that provides a mounting base for the compression cylinder 14, the intake valve 16, and the exhaust valve 18 of the fuel pump 10. More specifically, the pump housing 12 supports the compression cylinder 14, which in turn supports the intake valve 16 and the exhaust valve 18 of the fuel pump 10.

The compression cylinder 14 is coaxially positioned within the pump housing 12. The compression cylinder 14 includes a longitudinal cavity termed as a compression chamber 24. Additionally, the compression cylinder 14 includes an intake attachment portion 26 and an exhaust attachment portion 28, adjacent to the compression chamber 24 of the compression cylinder 14.

In the current embodiment, the intake valve 16 is an electrically actuated, unidirectional valve positioned in the intake attachment portion 26 of the compression cylinder 14. The intake valve 16 is in fluid communication with the compression chamber 24 of the compression cylinder 14. Moreover, the intake valve 16 is connected to a fuel supply (not shown) and facilitates a supply of fuel in the compression chamber 24 of the compression cylinder 14. Although, the intake valve 16 is described as an electrically actuated valve, various types of intake valves may be contemplated, such as but not limited to, a cam actuated intake valve, and a hydraulically actuated intake valve.

Similar to the intake valve 16, the exhaust valve 18 is an electrically operated, unidirectional valve positioned in the exhaust attachment portion 28 of the compression cylinder 14. The exhaust valve 18 is in fluid communication with the compression chamber 24 of the compression cylinder 14. The exhaust valve 18 is fluidly connected to a fuel exhaust (not shown) and facilitates exhaust of compressed fuel from the compression chamber 24 of the compression cylinder 14. Although, the exhaust valve 18 is described as an electrically actuated valve, various types of exhaust valves may be contemplated, such as but not limited to, a cam actuated exhaust valve, and a hydraulically actuated exhaust valve.

The plunger 20 is an elongated rod slideably positioned within the compression chamber 24 of the fuel pump 10. The plunger 20 includes a first end 30, proximal to the compression chamber 24 and a second end 32, distal to the compression chamber 24 of the fuel pump 10. The first end 30 is positioned within the compression chamber 24 and the second end 32 extends outwards of the compression chamber 24.

Moreover, the second end 32 of the plunger 20 includes a tappet assembly 34. The tappet assembly 34 supports a roller 36, which in turn is in slideable engagement with a cam lobe 38. This facilitates a connection between the second end 32 of the plunger 20 and the cam lobe 38, such that a rotary movement of the cam lobe 38 facilitates a reciprocatory movement of the plunger 20 within the compression chamber 24. The plunger 20 is adapted to reciprocate within the compression chamber 24 to intake fuel in the compression chamber 24, compress the fuel, and exhaust fuel from the compression chamber 24.

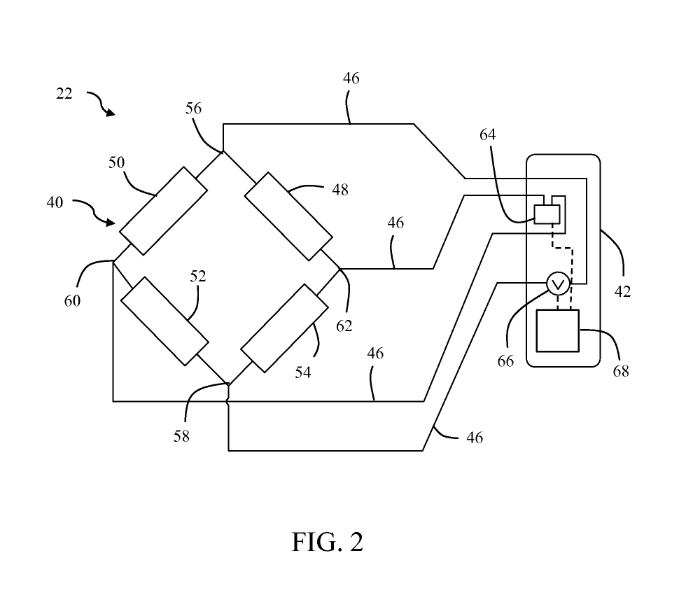

Referring to FIGS. 1 and 2, the load monitoring system 22 is shown. The load monitoring system 22 is employed to monitor and mitigate an axial load on the plunger 20 of the fuel pump 10. The load monitoring system 22 includes a strain gauge circuit 40 and a controller 42.

The strain gauge circuit 40 is a full bridge-type circuit. The strain gauge circuit 40 is attached to a peripheral portion 44 of the plunger 20 and is positioned within the fuel pump 10. The axial load on the plunger 20 corresponds to a change in voltage of the strain gauge circuit 40. Although, the strain gauge circuit 40 is described as a full bridge-type circuit, concepts of the present disclosure may be extended to several other types of the strain gauge circuit 40. Examples of other types of the strain gauge circuit 40 may include, but are not limited to, a quarter bridge type gauge circuit and a half bridge type circuit.

The controller 42 is a microcontroller unit positioned independent of the fuel pump 10. The controller 42 is electrically connected to the strain gauge circuit 40 via electrical wires 46. More specifically, the electrical wires 46 are routed through both of the tappet assembly 34 and the pump housing 12, to connect the strain gauge circuit 40 to the controller 42. The controller 42 is adapted to monitor the change in voltage of the strain gauge circuit 40. Although, the controller 42 in the present disclosure is described as an independent microcontroller, an extension to an electric control module of the engine may also be contemplated.

Referring to FIG. 2, there is shown various components and arrangements of the strain gauge circuit 40 and the controller 42 of the load monitoring system 22. In the current embodiment, the strain gauge circuit 40 includes a first strain gauge 48, a second strain gauge 50, a third strain gauge 52, and a fourth strain gauge 54. The first strain gauge 48 and the fourth strain gauge 54 are attached to the peripheral portion 44 of the plunger 20, such that the axial load on the plunger 20 applies a lateral stress on the first strain gauge 48 and the fourth strain gauge 54. Similarly, the second strain gauge 50 and the third strain gauge 52 are attached to the peripheral portion 44 of the plunger 20, such that the axial load on the plunger 20 applies a lateral stress on the first strain gauge 48 and the fourth strain gauge 54.

Furthermore, the first strain gauge 48, the second strain gauge 50, the third strain gauge 52, and the fourth strain gauge 54 are electrically connected to each other and form the full bridge-type of the strain gauge circuit 40. Arrangement between the first strain gauge 48, the second strain gauge 50, the third strain gauge 52, and the fourth strain gauge 54, is similar to a “wheat-stone bridge arrangement”. More particularly, the strain gauge circuit 40 defines a first terminal 56, a second terminal 58, a third terminal 60, and a fourth terminal 62. The first terminal 56 is defined between the first strain gauge 48 and the second strain gauge 50. The second terminal 58 is defined between the third strain gauge 52 and the fourth strain gauge 54. The third terminal 60 is defined between the second strain gauge 50 and the third strain gauge 52. The fourth terminal 62 is defined between the first strain gauge 48 and the fourth strain gauge 54. Furthermore, the strain gauge circuit 40 is electrically connected to the controller 42, via the electrical wires 46.

The controller 42 is a processing unit electrically connected to the intake valve 16 of the fuel pump 10. The controller 42 is capable of adjusting the intake valve 16, to alter the supply of fuel to the compression chamber 24, when required. The controller 42 includes a power supply 64, a voltmeter 66, and a memory unit 68.

The power supply 64 is connected between the first terminal 56 and the second terminal 58. The power supply 64 is adapted to apply an electric potential between the first terminal 56 and the second terminal 58 of the strain gauge circuit 40. Although, the power supply 64 is described as an integral component of the controller 42, it may be contemplated that the power supply 64 may be an independent component relative to the controller 42.

The voltmeter 66 is connected between the third terminal 60 and the fourth terminal 62. The voltmeter 66 of the controller 42 is adapted to monitor a change in voltage between the third terminal 60 and the fourth terminal 62. Although, the present disclosure describes the voltmeter 66 as an integral component of the controller 42, it may be contemplated that the voltmeter 66 may be a component independent of the controller 42.

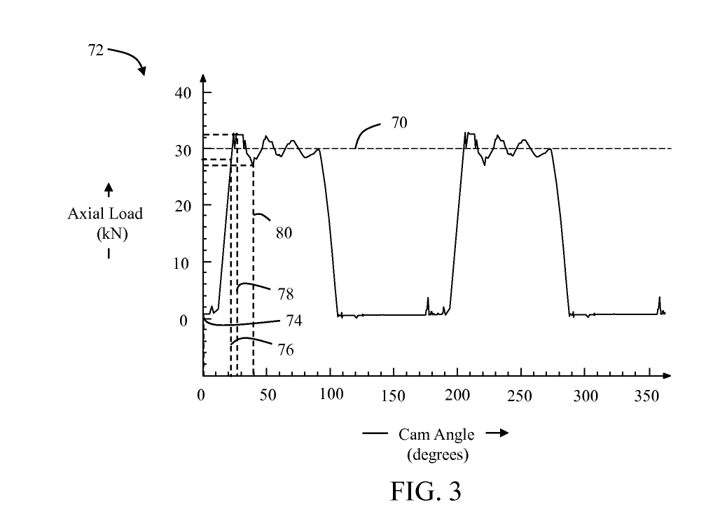

The memory unit 68 is electrically connected to both of the power supply 64 and the voltmeter 66. The memory unit 68 is adapted to store a threshold value 70 (FIG. 3) of the axial load that corresponds to a load-bearing capacity of the plunger 20. Additionally, the memory unit 68 is adapted to store a predetermined baseline data, as determined in an experimental state of the fuel pump 10. The predetermined baseline data is an array of experimental loads applied to the plunger 20 and a corresponding change in voltage observed at the voltmeter 66 of the controller 42. Notably, the threshold value 70 and the predetermined baseline data in the memory unit 68 can be over-written and/or modified with a new threshold value.

In an experimental state of the fuel pump 10, the base line data and the threshold data are stored in the memory unit 68 of the controller 42. For preparation of the predetermined baseline data, an operator applies experimental loads on the plunger 20 of the fuel pump 10. A corresponding change in voltage between the third terminal 60 and the fourth terminal 62 is observed at the voltmeter 66 of the controller 42. This change in voltage and the corresponding experimental loads are stored in the memory unit 68, as the predetermined baseline data of the fuel pump 10.

In an operational state of the fuel pump 10, fuel is supplied to the compression chamber 24 of the fuel pump 10. The plunger 20 reciprocates in the compression chamber 24, to compress and exhaust the compressed fluid form the compression chamber 24. At this instance, an axial load is applied on the plunger 20. This axial load on the plunger 20 facilitates the change in voltage of the strain gauge circuit 40, between the third terminal 60 and the fourth terminal 62. The controller 42 receives this change in voltage at the voltmeter 66 of the controller 42. Further, the controller 42 determines the axial load on the plunger 20, by comparing the change in voltage received at the voltmeter 66 with the base line data of the fuel pump 10. Moreover, the controller 42 compares this axial load with the threshold value 70 (FIG. 3). If the axial load is below the threshold value 70 (FIG. 3), the controller 42 adjusts the intake valve 16 to allow the supply of fuel to the compression chamber 24. If the axial load breaches the threshold value 70 (FIG. 3), the controller 42 adjusts the intake valve 16. to alter the supply of fuel to the fuel supplied to the compression chamber 24.

Referring to FIG. 3, there is shown a graph 72 between the axial load on an exemplary plunger 20 and cam angle of the cam lobe 38, in an operational state of the fuel pump 10. The plunger 20 is exemplarily based on steel and the threshold value 70 of the plunger 20 is set to 30000 Newton. However, the threshold value 70 stored in the memory unit 68 can be altered by an operator, based on the type of material of the plunger 20 of the fuel pump 10. In the current embodiment, fuel is delivered to the compression chamber 24 of the fuel pump 10 at a first point 74. At the first point 74, the plunger 20 is in a retracted state and the cam angle is zero degree. Therefore, the axial load on the plunger 20 is zero at the first point 74. Further, as the plunger 20 initiates to, the axial load on the plunger 20 increases.

At a second point 76, the cam angle of the cam lobe 38 is approximately 22 degrees and the axial load on the plunger 20 is approximately 29000 Newton. As this axial load is relatively lesser than the threshold value 70, the controller 42 allows a supply of fuel from the intake valve 16 to the compression chamber 24. At a third point 78 however, the cam angle of the cam lobe 38 is approximately 28 degrees and the axial load on the plunger 20 is approximately 32000 Newton. As this axial load on the plunger 20 is relatively higher than the threshold value 70, the controller 42 adjusts the intake valve 16, to alter the supply of fuel from the intake valve 16 to the compression chamber 24. Fluctuations in the axial load is observed due to surges of fuel pressure. Thereafter, at the fourth point 80 cam angle of the cam lobe 38 is approximately 40 degrees and the axial load is approximately 27000 Newton. As this axial load on the plunger 20 again reaches below the threshold value 70, the controller 42 adjusts the intake valve 16, to allow the supply fuel to the compression chamber 24 of the fuel pump 10. This process is continuously performed in entire fuel delivery cycle, to mitigate the axial load on the plunger 20 of the fuel pump 10

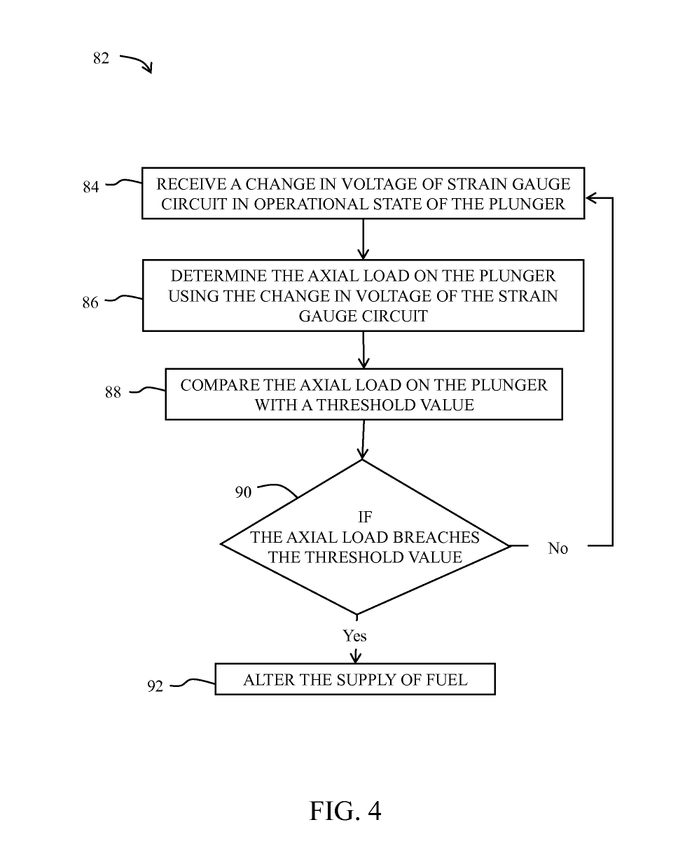

Referring to FIG. 4, there is shown a flow chart of the method mitigating an axial load on the plunger 20 of the fuel pump 10. The method initiates at step 84.

At step 84, the operator sets the fuel pump 10 in an operational state and the controller 42 receives a change in voltage of the fuel pump 10. In the operational state, the intake valve 16 delivers fuel in the compression chamber 24 of the fuel pump 10, and the axial load is applied on the plunger 20. This axial load facilitates a change in voltage of the strain gauge circuit 40 between the third terminal 60 and the fourth terminal 62 of the strain gauge circuit 40. The controller 42 receives this change in voltage at the voltmeter 66 of the controller 42. The method then proceeds to step 86.

At step 86, the controller 42 determines the axial load applied on the plunger 20 by use of the change in voltage received by the voltmeter 66 of the controller 42. More specifically, the controller 42 compares the change in voltage with the predetermined baseline data to determine the axial load on the plunger 20. The method then proceeds to step 88.

At step 88, the controller 42 compares the axial load with the threshold value 70 of the plunger 20. The method then proceeds to step 90.

At step 90, the controller 42 determines whether the axial load on the plunger 20 breaches the threshold value 70. If the axial load as determined by the controller 42 to breach the threshold value 70, the method proceeds to end step 92. If the axial load as determined by the controller 42 is below the threshold value 70, the method returns to step 84.

At end step 92, the controller 42 adjusts the intake valve 16 to regulate the supply of in the compression chamber 24 of the fuel pump 10. This mitigates the axial load on the plunger 20 of the fuel pump 10.

### INDUSTRIAL APPLICABILITY

In operation, a method of mitigating the axial load on the plunger 20 of the fuel pump 10 initiates with preparation of the predetermined baseline data in an experimental state of the fuel pump 10. For this purpose, an operator initially sets the fuel pump 10 in the experimental state. In the experimental state, no fuel is supplied to the compression chamber 24 of the fuel pump 10. For preparation of the predetermined baseline data, an operator applies experimental axial loads on the plunger 20. Subsequently, the controller 42 tallies a change in voltage observed at the voltmeter 66. Thereafter, the operator stores this predetermined baseline data in the memory unit 68 of the controller 42. Additionally, the operator stores the threshold value 70 for the type of plunger 20 in the memory unit 68 of the controller 42. This facilitates the load monitoring system 22 to mitigate the axial load on different types of plunger 20. For example, if the plunger 20 is based on aluminum, the threshold value 70 of the plunger 20 may be \altered. As the load monitoring system 22 facilitates an alteration in the threshold value 70 for different types of the plunger 20, the axial load is accurately mitigated for each type of the plunger 20. In this manner, the predetermined baseline data associated with plunger 20 is prepared and is stored in the memory unit 68 of the controller 42. Thereafter, the operator adjusts the fuel pump 10 in the operational state.

In the operational state of the fuel pump 10, the intake valve 16 delivers fuel in the compression chamber 24 of the fuel pump 10. The plunger 20 reciprocates within the compression chamber 24 to facilitate compression and exhaust of the fuel at a predetermined pressure. This exerts an axial load on the first end 30 of the plunger 20, which peaks at the time of compression of the fuel pump 10. In the current embodiment, the voltmeter 66 of the controller 42 receives a change in voltage of the strain gauge circuit 40 at the voltmeter 66 of the controller 42, associated with the axial load. The controller 42 then compares the change in voltage of the strain gauge circuit 40 with the predetermined baseline data stored in the memory unit 68 of the controller 42, to inversely determine the axial load on the plunger 20. Further, the controller 42 compares the axial load with the threshold value 70, stored in the memory unit 68 of the controller 42. If the axial load as determined by the controller 42 breaches the threshold value 70, the controller 42 adjusts the intake valve 16 to alter the supply of fuel received in the compression chamber 24. This mitigates the axial load on the plunger 20 of the fuel pump 10.

The above perspective is particularly applicable when the fuel pump 10 is adjusted to deliver fuel at a pressure relatively high pressure compared to the load-bearing capacity (threshold value 70) of the plunger 20 of the fuel pump 10. In such situations, the axial load is likely to exceed the threshold value 70. In the current disclosure, the controller 42 adjusts the intake valve 16 to alter the supply of fuel to the compression chamber 24 of the fuel pump 10. This results in an increased work life of the plunger 20 and the fuel pump 10. Moreover, the axial load is calculated directly from the change in voltage of the strain gauge circuit 40. This provides relatively accurate results for the mitigation of the axial loads on the plunger 20 of the fuel pump 10.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A method of mitigating axial load on a plunger of a fuel pump, the fuel pump including a compression chamber adapted to receive a supply of fuel in an operational state of the fuel pump and facilitate exertion of an axial load on the plunger, the plunger including a strain gauge circuit to determine the axial load, the method comprising:
receiving a change in voltage of the strain gauge circuit corresponding the axial load exerted by the compression chamber, in the operational state of the fuel pump;
using the change in voltage of the strain gauge circuit to inversely determine the axial load on the plunger, the determination being based on a comparison of the change in voltage of the strain gauge circuit received in the operational state of the fuel pump with a predetermined baseline data;
comparing the axial load on the plunger with a threshold value; and
altering the supply of fuel to the compression chamber of the fuel pump, if the axial load breaches the threshold value.
